(19) United States
(12) Patent Application Publication
(10) Pub. No.: US 2025/0177937 A1
(43) Pub. Date: Jun. 5, 2025

(54) Liquid Polymer Dosing and Mixing Chamber with an External Actuator

(71) Applicant: Adalberto Mercado Alvarado, Bayamon, PR (US)

(72) Inventor: Adalberto Mercado Alvarado, Bayamon, PR (US)

(21) Appl. No.: 19/041,033

(22) Filed: Jan. 30, 2025

Related U.S. Application Data
(63) Continuation-in-part of application No. 17/889,016, filed on Aug. 16, 2022.

(51) Int. Cl. B01F 35/71; B01F 23/43; B01F 27/91; B01F 35/30; B01F 35/32; B01F 101/00; B01J 4/00; B01J 19/00; B01J 19/18; F04C 2/107; F04C 15/06

(52) U.S. Cl. CPC B01F 35/7176; B01F 23/43; B01F 27/91; B01F 35/323; B01F 35/3231; B01F 35/712; B01J 4/007; B01J 19/0066; B01J 19/1818; F04C 2/1073; F04C 15/06; B01F 2035/351; B01F 2101/2204; B01F 2101/2805; B01J 2204/002; F04C 2210/20

(57) ABSTRACT

A liquid polymer dosing and mixing chamber and pump having a pump housing, a mixing reactor, a spacing cup, an actuator, a drive shaft, a drive shaft coupling unit, and a progressive cavity pump adapted to create doses of a first substance and to mix it with one or more substances introduced into the mixing reactor via one or more inlets.

### CROSS-REFERENCE TO RELATED APPLICATION

This application is a continuation-in-part of, and claims the benefit of priority to, U.S. patent application Ser. No. 17/889,016, entitled “Liquid Polymer Dosing and Mixing Chamber & Pump”, and filed on Aug. 16, 2022, the contents of which are hereby incorporated by reference.

### STATEMENT REGARDING FEDERALLY SPONSORED RESEARCH AND DEVELOPMENT

N/A

### BACKGROUND OF THE INVENTION

### Field of the Invention

The present invention relates to polymer dosing and mixing chamber & pump.

### Discussion of the Background

Mechanical blending systems are widely utilized in various industries to separate liquids from solids (and vice versa). These systems are essential in facilities such as water treatment plants, wastewater treatment plants, pharmaceutical plants, food and beverage facilities, dairy operations, distilleries, power plants, industrial plants, and mining processing facilities.

Standard polymer blending systems, both mechanical and non-mechanical, typically employ a single energy reaction chamber to dilute and activate polymers. These systems rely heavily on high inlet water pressure to maintain a consistent blend. However, when the inlet pressure drops, the consistent blend can turn into a variable blend. In such cases, operators often resort to two actions that increase operational costs: 1) increasing the polymer dosing pump capacity; and 2) reducing production rates to maintain process stability.

Furthermore, many components in blending systems require replacement over time due to wear and tear. This process can be challenging and time-consuming, especially when operators lack visibility into the malfunctioning components within the system. Therefore, there is a strong demand for a polymer dosing and mixing reactor with improved accessibility. A reactor design that allows operators easy access to its interior would significantly enhance maintenance efficiency.

Among the system components, the stator is the most frequently replaced part. Consequently, it is desirable to have a stator that is both easy to replace and quick to install, minimizing downtime and improving overall system reliability.

### SUMMARY OF THE INVENTION

A liquid polymer dosing and mixing chamber, comprising a pump housing, a mixing reactor, a spacing cup, an actuator, a drive shaft, a drive shaft coupling unit, and a progressive cavity pump; wherein the pump housing comprises a longitudinal body having a top end and an opposing bottom end, and wherein said pump housing is adapted to house the progressive cavity pump; wherein the bottom end of the pump housing includes an inlet configured to receive a first substance and direct it into the progressive cavity pump; wherein the progressive cavity pump comprises a rotor and a stator, said rotor being configured to interact with and fit inside the stator; wherein the top end of the pump housing has an opening to transfer the first substance from the progressive cavity pump into the mixing reactor; wherein the mixing reactor comprises a hollow tube having a top end and a bottom end opposite each other, and wherein said mixing reactor is configured to house the drive shaft; wherein the drive shaft comprises a longitudinal body having a top end, a bottom end, and one or more impellers, and wherein the one or more impellers are positioned between the top end and the bottom end of the drive shaft; wherein the drive shaft coupling unit comprises a top end and an opposing bottom end; wherein the rotor comprises a coupling unit configured to couple or connect to the bottom end of the drive shaft; wherein the hollow tube of the mixing reactor includes one or more inlets and one or more outlets attached to the hollow tube of the mixing reactor; wherein the one or more inlets on the hollow tube of the mixing reactor are adapted to receive at least a second substance to be mixed in the mixing reactor with the first substance drawn from the progressive cavity pump; wherein the spacing cup comprises a longitudinal structure having a top section, a bottom section, and one or more exterior walls, wherein the exterior walls are flanked between the top section and the bottom section of the spacing cup; wherein the spacing cup comprises an interior area that is adapted to house the drive shaft coupling unit; a sealing plate between the bottom section of the separation cup and the top end of the mixing reactor to prevent the mixed substances inside the mixing reactor from entering the spacing cup; wherein the top end of the pump housing is connected to the bottom end of the mixing reactor and the top end of the mixing reactor is connected to the bottom section of the spacing cup; wherein the top end of the drive shaft coupling unit is coupled to the actuator, and the bottom end of the drive shaft coupling unit is coupled to the top end of the drive shaft; wherein the bottom end of the drive shaft is coupled to the coupling unit of the rotor; and wherein the actuator transmits rotational motion to the drive shaft, which in turn, drives the rotor.

### BRIEF DESCRIPTION OF THE DRAWINGS

FIG. 1 shows a perspective view of a liquid polymer dosing and mixing chamber, in accordance with the principles of the present invention.

FIG. 2 shows a perspective side view of a liquid polymer dosing and mixing chamber, in accordance with the principles of the present invention.

FIG. 3 shows an exploded view of the liquid polymer dosing and mixing chamber, in accordance with the principles of the present invention.

FIG. 4 is a perspective view of a dual liquid polymer dosing and mixing chamber, in accordance with the principles of the present invention.

FIG. 5 shows a front view of the dual liquid polymer dosing and mixing chamber, in accordance with the principles of the present invention.

FIG. 6 shows a rear view of the dual liquid polymer dosing and mixing chamber, in accordance with the principles of the present invention.

FIG. 7 shows a top view of the dual liquid polymer dosing and mixing chamber, in accordance with the principles of the present invention.

FIG. 8 shows a bottom view of the dual liquid polymer dosing and mixing chamber, in accordance with the principles of the present invention.

FIG. 9 shows a rear perspective view of the dual liquid polymer dosing and mixing chamber, in accordance with the principles of the present invention.

FIG. 10 shows another rear perspective view of the dual liquid polymer dosing and mixing chamber, in accordance with the principles of the present invention.

FIG. 11 shows the internal components of the dual liquid polymer dosing and mixing chamber, in accordance with the principles of the present invention.

FIG. 12 shows the flow of substances along the liquid polymer dosing and mixing chamber, in accordance with the principles of the present invention.

FIG. 13 shows the flow of substances within the dual liquid polymer along the dual liquid polymer dosing and mixing chamber, in accordance with the principles of the present invention.

FIG. 14 shows another embodiment of the liquid polymer along the liquid polymer dosing and mixing chamber.

FIG. 15 shows the drive shaft component of the liquid polymer dosing and mixing chamber, in accordance with the principles of the present invention.

FIG. 16 shows the spacing cup component of the liquid polymer dosing and mixing chamber, in accordance with the principles of the present invention.

FIG. 17 shows the progressive cavity pump component of the liquid polymer dosing and mixing chamber, in accordance with the principles of the present invention.

### DETAILED DESCRIPTION OF THE INVENTION

The present disclosure discloses several exemplary embodiments of a liquid polymer dosing and mixing chamber that is driven by a submersible motor or actuator as well as a dosing pump that incorporates components from the liquid polymer dosing and mixing chamber, as further described below.

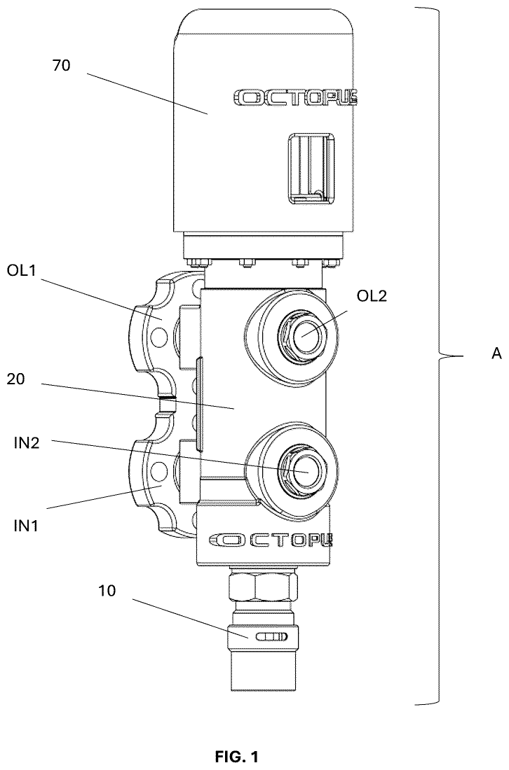

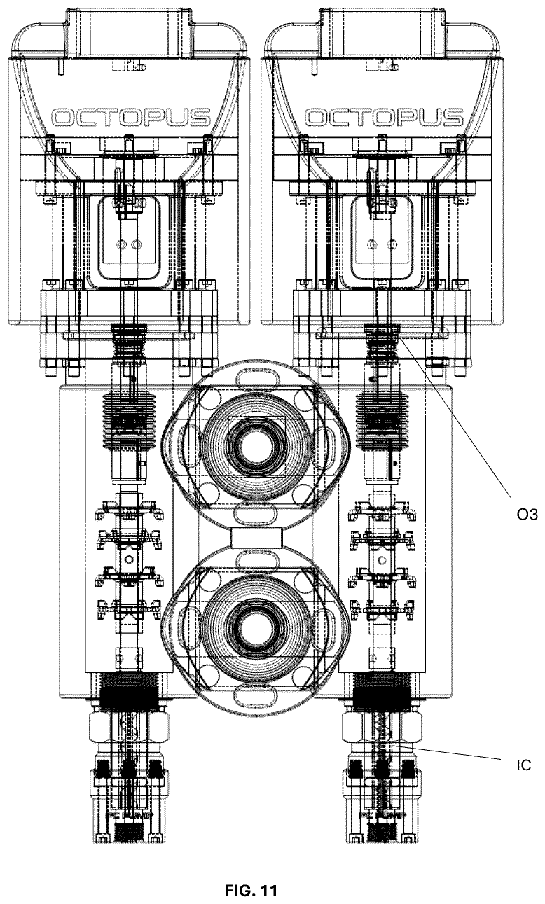

FIGS. 1-3, 10, and 14 show a liquid polymer dosing and mixing chamber A comprising a pump housing 10, a mixing reactor 20, a spacing cup 30, an actuator 40, a drive shaft 50, a drive shaft coupling unit 60, and a progressive cavity pump CP. The pump housing 10 comprises a longitudinal body with a top end 10a and an opposing bottom end 10b, wherein said pump housing 10 is adapted to house the progressive cavity pump CP. The bottom end 10b of the pump housing 10 includes an inlet 10c configured to receive a first substance (e.g., one or more polymers) and direct it into the progressive cavity pump CP. Conversely, the top end 10a of the pump housing 10 has an opening 10d designed to transfer the first substance from the progressive cavity pump CP into the mixing reactor 20. It should be noted that the top end 10b of the pump housing 10 is configured to connect or interface with the bottom portion 20b of the mixing reactor 20, as further detailed below.

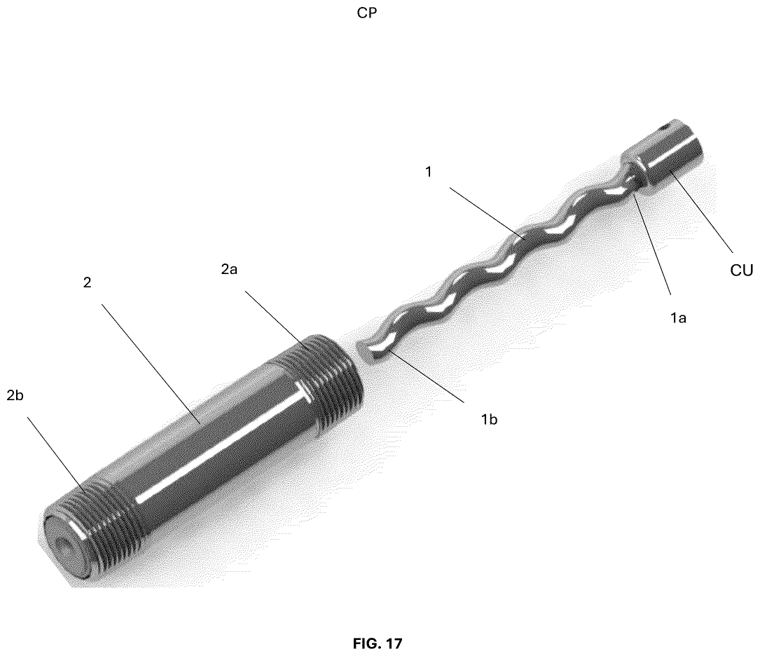

The progressive cavity pump CP, in turn, comprises a rotor 1 and a stator 2, wherein the rotor 1 is configured to interact with and fit inside the stator 2; and wherein the progressive cavity pump CP is enclosed within the pump housing 10. This enclosure is achieved through an internal chamber IC within the pump housing 10, designed to tightly hold the progressive cavity pump CP in place, as shown in FIG. 11. The basic working principle of the progressive cavity pump CP involves a rotor 1, typically made of solid metal and shaped as a single helix, rotating within the stator 2, which features a double-helix cavity. As shown in FIG. 17, the rotor 1 comprises a top end 1a and a bottom end 1b opposite each other, wherein the top end 1a of the rotor 1 comprises a coupling unit CU configured to couple or connect to the bottom end 50b of the drive shaft 50, thereby locking the top end 1a of the rotor 1 to the drive shaft 50. As further shown in FIG. 17, the stator 2, which surrounds and covers the rotor 1, also comprises a first end 2a and a second end 2b opposite each other.

As the rotor 1 rotates, it generates a vacuum that draws the first substance from the inlet 10c toward the mixing reactor 20. During this process, the rotor 1 divides the first substance into discrete doses as it moves through the progressive cavity pump CP. It should be noted that the rotor 1 is constructed from spiral stainless steel, but alternative materials such as high-strength plastics or other types of steel can also be used. The stator 2 typically comprises a metal pipe or tube with an internally molded cavity made from materials such as NBR, EPDM (black or white), FKM, Viton®, HNBR, PTFE, Silicone, or 3D-printed thermoplastic elastomers. Other options include branded materials such as Perbunan®, Nitril®, or Teflon®. It should also be noted that the rotor 1 is actuated or rotated by the actuator 40. Such rotation is possible because the top end 1a of the rotor 1 is coupled to a bottom end of the drive shaft 50 via a coupling mechanism CU. Specifically, the coupling mechanism CU on the top end of the rotor 1 includes an opening adapted to receive the bottom end 50b of the drive shaft 50, allowing the drive shaft 50 to latch itself to the rotor 1.

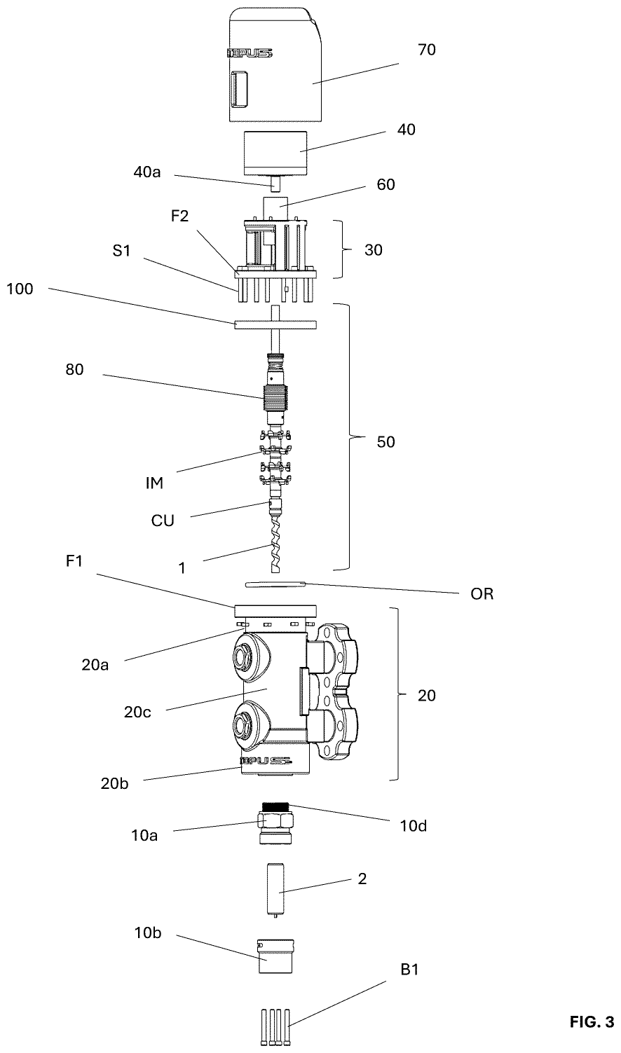

In one embodiment of the liquid polymer dosing and mixing chamber A, the bottom end 10b and the top end of 10a of the pump housing 10 are separate or individual sections that are attached to each other via one or more bolts B1, as shown in FIG. 3. In this embodiment, the bottom end 10b includes one or more openings H1-4 adapted to receive the one or more bolts B1. Likewise, the top end 10a includes one or more openings that align with the one or more openings H1-4 in the bottom end 10a and are adapted to receive the one or more bolts B1 in order to secure the bottom end 10b to the top end 10a of the pump housing 10.

The mixing reactor 20, in turn, comprises a hollow tube 20c having a top end 20a and a bottom end 20b opposite each other, wherein said mixing reactor 20 is configured to house the drive shaft 50, as shown in FIG. 3. The drive shaft 50 comprises a longitudinal body having a top end 50a, a bottom end 50b, and one or more impellers IM, wherein the bottom end 50b is opposite the top end 50a and the one or more impellers IM are positioned between the top end 50a and bottom end 50b of the drive shaft 50, as further discussed below. Moreover, the hollow tube 20a of the mixing reactor 20 includes one or more inlets IN1-IN2 and one or more outlets OL1-OL2 attached perpendicularly to the hollow tube 20a of the mixing reactor 20. The one or more inlets IN1-IN2 are adapted to receive at least a second substance (e.g., water) to be mixed in the mixing reactor 20, via the agitation of the one or more impellers IM, with the first substance drawn from the progressive cavity pump CP. Once mixing is complete, the outlets OL1-OL2 are configured to discharge the mixed substances from the mixing reactor 20.

The top end 20a of the mixing reactor 20 may include a flange F1 configured to connect to the bottom section 30b of the spacing cup 30 via one or more bolts or screws S1, as shown in FIG. 3. Particularly, the flange F1 on the top end 20a of the mixing reactor 20 includes one or more openings that i) align with corresponding openings on the bottom section 30b of the spacing cup 30, and ii) are adapted to receive the one or more bolts or screws S1 to secure the top end of the mixing reactor 20 to the bottom section 30b of the spacing cup 30, as further detailed below. The bottom end 20b of the mixing reactor 20, in turn, is configured to connect with the top end 10a of the pump housing 10. For instance, the top end 10a of the pump housing 10 may include a male threaded connector adapted to mate or connect with a female threaded connector on the bottom portion 20b of the mixing reactor 20. Likewise, the inlets IN1-IN2 may also comprise a female-threaded connector adapted to mate with other parts having male-threaded connectors. To ensure a leak-proof connection, an O-ring OR may be positioned between the top end 20a of the mixing reactor 20 and the bottom section 30b of the spacing cup 30, as well as between the bottom end 20b of the mixing reactor 20 and the top end 10a of the pump housing 10. These O-rings prevent leakage of liquids or substances at the connection points.

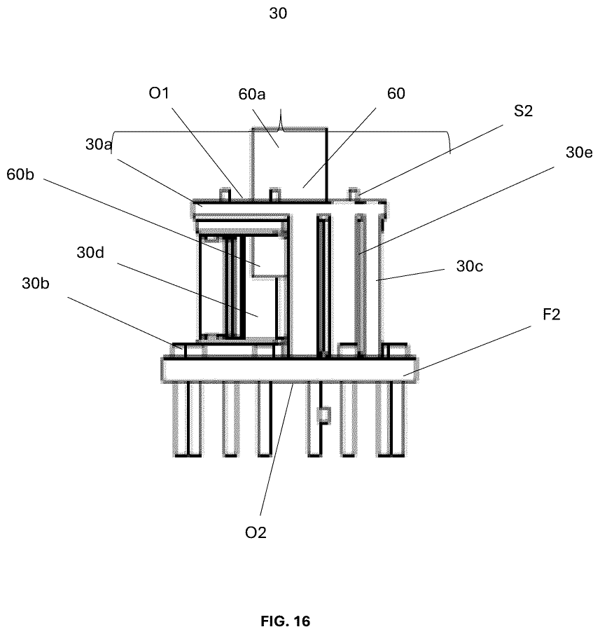

As shown in FIG. 16, the spacing cup 30 comprises a longitudinal structure having a top section 30a, a bottom section 30b, and one or more exterior walls 30c, wherein the exterior walls 30c are flanked between the top section 30a and the bottom section 30b of the spacing cup 30. Moreover, the spacing cup 30 comprises an interior area 30d that is adapted to house the drive shaft coupling unit 60. The drive shaft coupling unit 60, in turn, includes a top end 60a and an opposing bottom end 60b; wherein the top end 60a is adapted to couple with an actuator drive shaft 40a located on the actuator 40; and wherein the bottom end 60b is adapted to couple to the top end 50a of the drive shaft 50. As shown in FIG. 3, the bottom section 30b of the spacing cup 30, may include a flange F2 with one or more openings that align with the one or more openings on the flange F1 on the top end 20a of the mixing reactor 20. The openings on both flanges F1 and F2 are adapted to receive the one or more screws, or fasteners S1 to secure the spacing cup 30 to the mixing reactor 20, as previously discussed. Likewise, the top section 30a of the spacing cup 30 includes one or more openings adapted to receive one or more bolts S2 that secure the actuator 40 to spacing cup 30, ensuring a stable connection. It should be noted that the actuator 40 may be an electric motor or actuator; a hydraulic motor; or preferably a pneumatic motor. As noted, the actuator 40 includes an drive shaft 40a that connects to the top end 60a of the drive shaft coupling unit 60. The coupling unit 60, in turn, transmits rotational motion to the drive shaft 50, which drives the rotor 1. This rotational motion powers the operation of the liquid polymer dosing and mixing chamber A, ensuring efficient performance.

The exterior walls 30c of the spacing cup 30 may optionally include one or more openings or windows 30e configured to provide ventilation and/or a view of the interior area 30c of the spacing cup, as shown in FIG. 16. The top section 30a of the spacing cup 30 includes an opening O1 adapted to provide the actuator drive shaft 40a with access into the interior area 30c of the spacing cup 30 so that it (i.e., the actuator drive shaft 40a ) can be attached to the shaft coupling unit 60. Likewise, the bottom section 30b of the spacing cup 30 also includes an opening O2 that provides the top end 50a of the drive shaft 50 with access into the interior area 30c of the spacing cup 30 so that it (i.e., the drive shaft 50) can be attached to the shaft coupling unit 60. The bottom end 50b of the drive shaft 50, on the other hand, is connected to the rotor 1, as previously indicated.

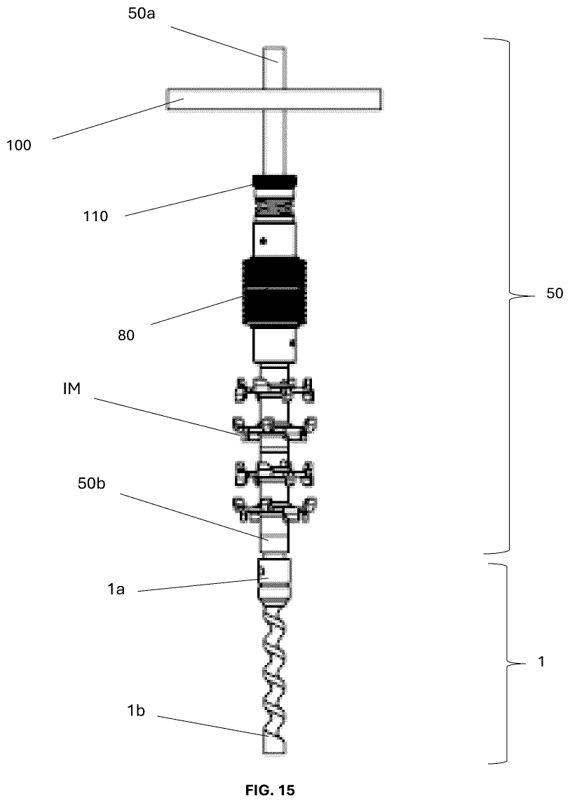

Moreover, the liquid polymer dosing and mixing chamber A comprises a sealing plate 100 between the bottom end 30b of the separation cup 30 and the top end 20b of the mixing reactor 20 to prevent the substances or liquids inside the mixing reactor from entering the spacing cup 30, as shown in FIGS. 3 and 15. The sealing plate 100 includes an opening O3 at its center adapted to receive the top end 50a of the drive shaft 50 with access into the interior area 30c of the spacing cup 30 so that the drive shaft 50 can be attached to the shaft coupling unit 60. Furthermore, the sealing plate 100 comprises one or more openings, at or near its perimeter, that i) align with the corresponding openings on the bottom section 30b of the spacing cup 30 and the top end 20a of the mixing reactor 20; and ii) are adapted to receive the one or more bolts or screws S1 to secure the sealing plate 100 between the top end 20a of the mixing reactor 20 and the bottom end 30b of the spacing cup 30.

As shown in FIG. 15, the drive shaft 50 comprises a top end 50a, a bottom 50b, and one or more impellers flanked between the top end 50a and bottom end 50b of the drive shaft 50, wherein the top end 50a of the drive shaft 50 is coupled to the bottom end 60b of the drive shaft coupling unit 60; and the bottom end 50b of the drive shaft 50 is coupled to the top end of the rotor 1 via the coupling unit CU of the rotor 1. The drive shaft 50 may also include a flexible joint 80 that absorbs and dissipates energy through its ability to compress, stretch, or deform elastically in response to the vibration of the drive shaft 50 during operation of the actuator 40 and impellers IM. Moreover, the drive shaft 50 may also comprise a mechanical seal 110 to prevent the access of liquid or substances from the mixing reactor 20 into the spacing cup 30. The mechanical seal 110 covers and/or surrounds a portion near the top end 50a of the drive shaft 50 and seals the opening O3 on the sealing plate 100. This way, no liquid or substances can get into the spacing cup 30 or reach the actuator 40. For this reason, the actuator 40 is external instead of a submersible actuator.

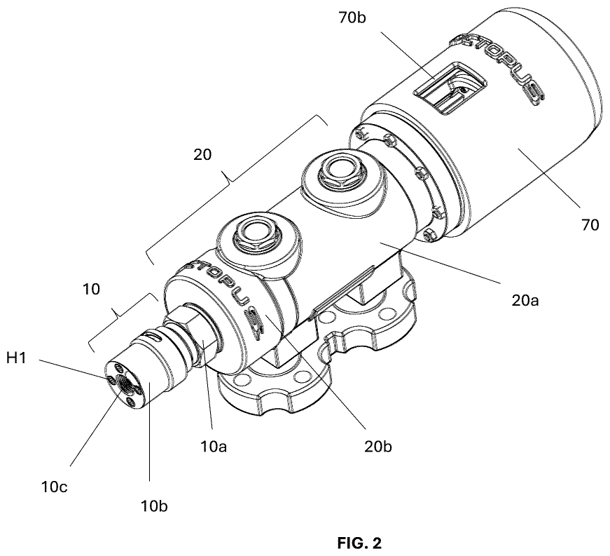

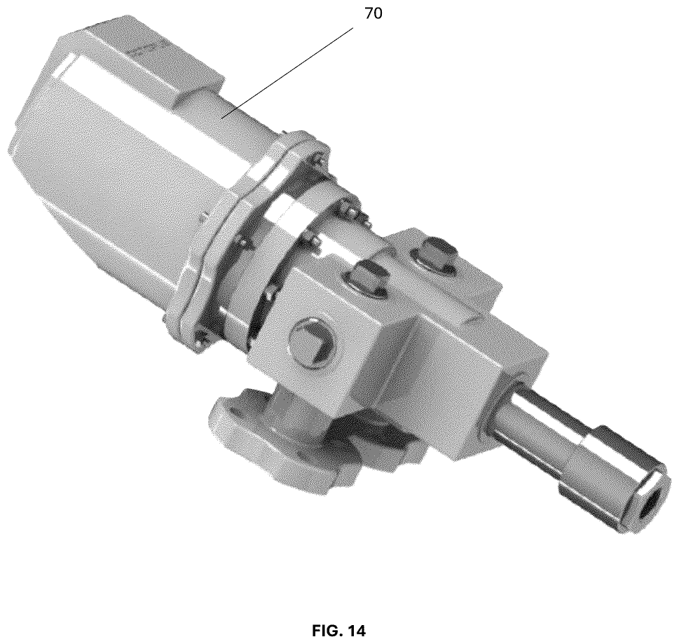

The liquid polymer dosing and mixing chamber A may also include a protective cap 70 adapted to protect and follow the contour of the actuator 40 and spacing cup 30, as shown in FIGS. 1 and 2. The protective cap 70 preferably has a semicircular configuration and is adapted to tightly fit around the actuator 40 and spacing cup 30. The protective cap 70 may also include an opening 70b that provides access or a view into the interior of the spacing cup 30. Due to its semicircular configuration, the protective cap 70 also includes a cutout section or open space 70a that leaves a portion of the actuator 40 and the spacing cup 30 exposed, thereby providing the actuator 40 with ventilation. In another embodiment, however, the protective cap 70 may cover the entirety of the actuator 40 and spacing cup 30, as shown in FIG. 14.

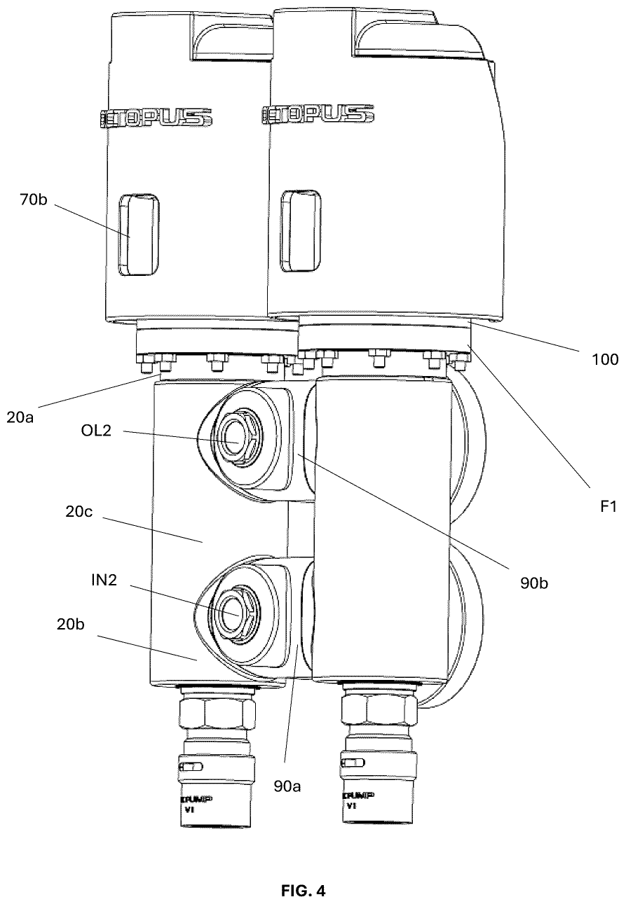

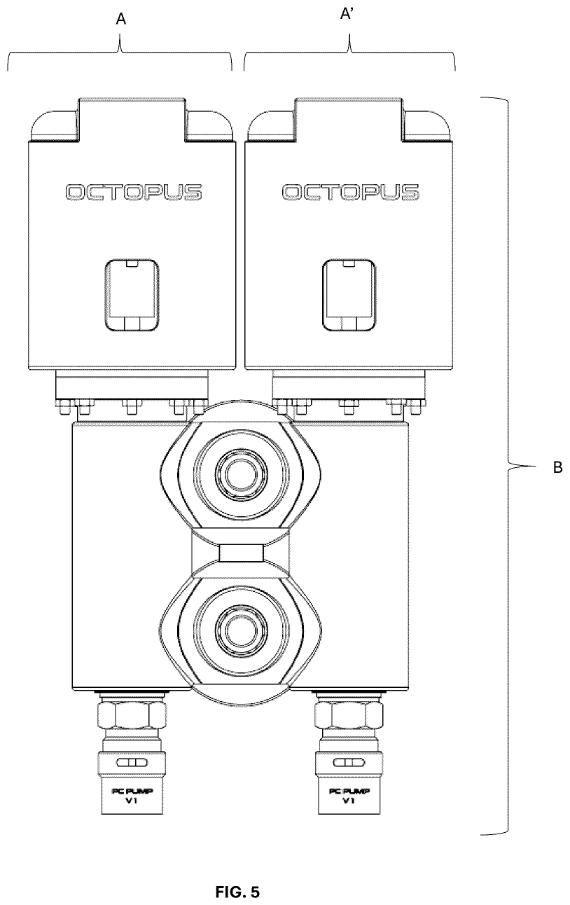

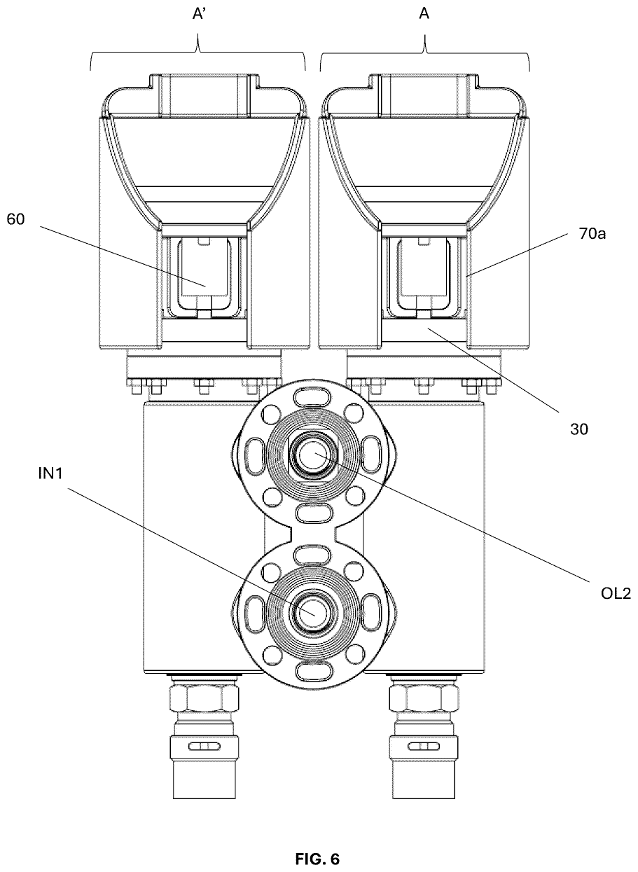

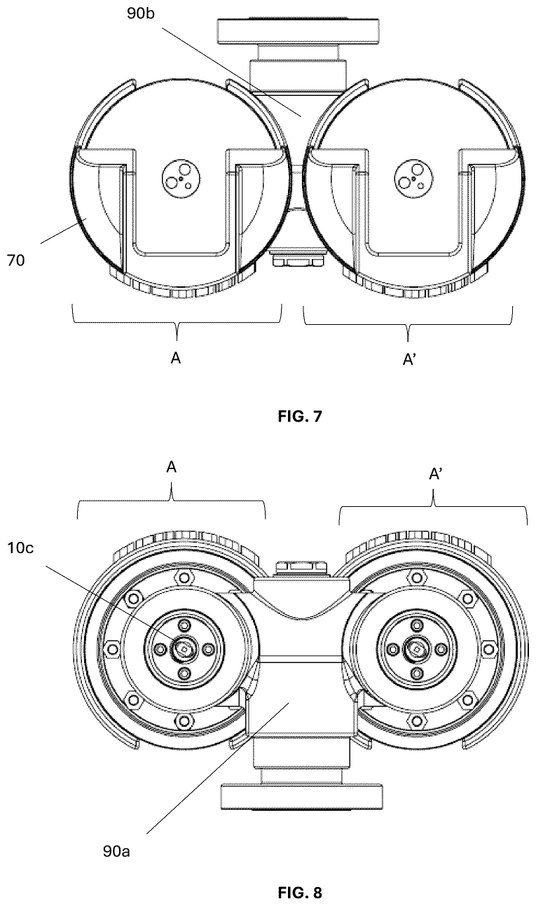

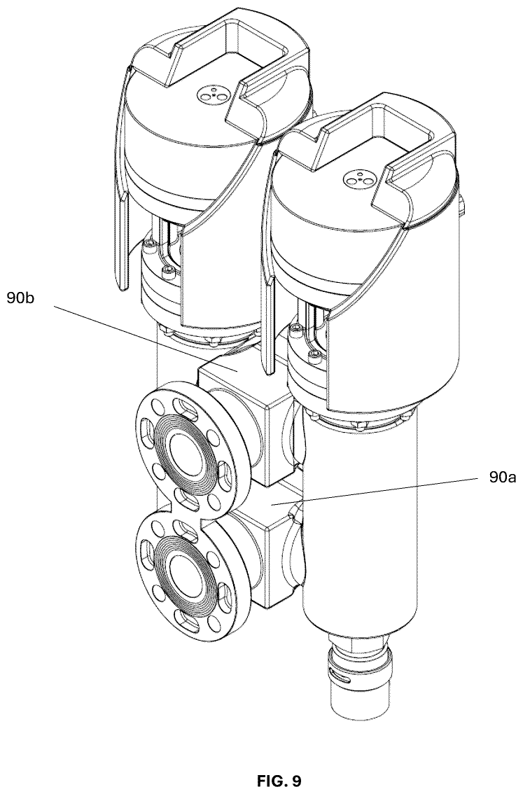

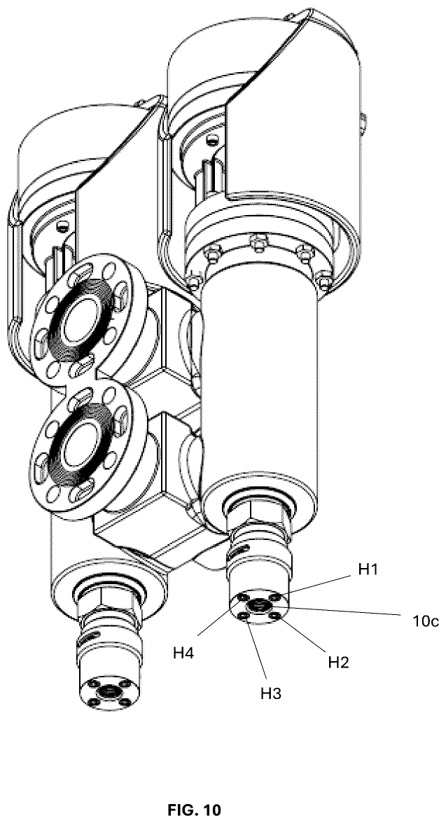

FIGS. 4-9, and 11 show a dual liquid polymer dosing and mixing chamber B that includes two liquid polymer dosing and mixing chambers having the same components described above, except for two key differences. The first difference is that the mixing reactors 20 of each liquid polymer dosing and mixing chamber A and A′ are connected to each other via a bottom connecting tube 90a and a top connecting tube 90b, as shown in FIG. 4. Specifically, the bottom connecting tube 90a perpendicularly connects both mixing reactors 20 to each other at an area adjacent to the bottom end 20b of both mixing reactors 20; whereas the top connecting tube 90b perpendicularly connects both mixing reactors 20 at an area adjacent to top end 20a of both mixing reactors 20. The second difference is that the one or more inlets IN1-IN2 and one or more outlets OL1-OL2 are perpendicularly connected to the connecting tubes 90a and 90b instead of on the mixing reactor 20. The one or more inlets IN1-IN2 should be preferably located on the bottom connecting tube 90a, whereas the one or more outlets OL1-OL2 should be preferably located on the top connecting tube 90b. It should be noted, however, that each of the mixing reactors 20 may be connected to each other via a single connecting tube instead of two, wherein the single connecting tube comprises at least one inlet adapted to receive a second substance to be mixed with the corresponding first substances in the corresponding mixing reactors 20; and at least one outlet adapted to release or expel the mixed substances from the dual liquid polymer dosing and mixing chamber B.

As such, the dual liquid polymer dosing and mixing chamber B comprises a first pump housing, a first mixing reactor, a first spacing cup, a first actuator, a first drive shaft, a first drive shaft coupling unit, and a first progressive cavity pump; wherein the first pump housing comprises a longitudinal body having a top end and an opposing bottom end, and wherein said first pump housing is adapted to house the first progressive cavity pump; wherein the bottom end of the first pump housing includes an inlet configured to receive a first substance and direct it into the first progressive cavity pump; wherein the first progressive cavity pump comprises a first rotor and a first stator, said first rotor being configured to interact with and fit inside the first stator; wherein the top end of the first pump housing has an opening to transfer the first substance from the first progressive cavity pump into the first mixing reactor; wherein the first mixing reactor comprises a hollow tube having a top end and a bottom end opposite each other, wherein said first mixing reactor is configured to house the first drive shaft; wherein the first drive shaft comprises a longitudinal body having a top end, a bottom end, and one or more impellers, and wherein the one or more impellers are positioned between the top end and the bottom end of the first drive shaft; wherein the first drive shaft coupling unit comprises a top end and an opposing bottom end; wherein the first rotor comprises a coupling unit adapted to couple or connect to the bottom end of the first drive shaft; wherein the first spacing cup comprises a longitudinal structure having a top section, a bottom section, and one or more exterior walls, wherein the exterior walls are flanked between the top section and the bottom section of the first spacing cup; wherein the first spacing cup comprises an interior area that is adapted to house the first drive shaft coupling unit; a first sealing plate between the bottom section of the first separation cup and the top end of the first mixing reactor to prevent the mixed substances inside the first mixing reactor from entering the first spacing cup; wherein the top end of the first pump housing is connected to the bottom end of the first mixing reactor and the top end of the first mixing reactor is connected to the bottom section of the first spacing cup; wherein the top end of the first drive shaft coupling unit is coupled to the first actuator, and the bottom end of the first drive shaft coupling unit is coupled to the top end of the first drive shaft; wherein the bottom end of the first drive shaft is coupled to the coupling unit of the first rotor; and wherein the first actuator transmits rotational motion to the first drive shaft, which in turn, drives the first rotor;

The dual liquid polymer dosing and mixing chamber B further a second pump housing, a second mixing reactor, a second spacing cup, a second actuator, a second drive shaft, a second drive shaft coupling unit, and a second progressive cavity pump; wherein the second pump housing comprises a longitudinal body having a top end and an opposing bottom end, and wherein said second pump housing is adapted to house the second progressive cavity pump; wherein the bottom end of the second pump housing includes an inlet configured to receive a first substance and direct it into the second progressive cavity pump; wherein the second progressive cavity pump comprises a second rotor and a second stator, said second rotor being configured to interact with and fit inside the second stator; wherein the top end of the second pump housing has an opening to transfer the first substance from the second progressive cavity pump into the second mixing reactor; wherein the second mixing reactor comprises a hollow tube having a top end and a bottom end opposite each other, wherein said second mixing reactor is configured to house the second drive shaft; wherein the second drive shaft comprises a longitudinal body having a top end, a bottom end, and one or more impellers, wherein the bottom end and the top end of the drive shaft are opposite each other and wherein the one or more impellers are positioned between the top end and bottom end of the second drive shaft; wherein the second drive shaft coupling unit comprises a top end and an opposing bottom end; wherein the second rotor comprises a coupling unit adapted to couple or connect to the bottom end of the second drive shaft; wherein the second spacing cup comprises a longitudinal structure having a top section, a bottom section, and one or more exterior walls, and wherein the exterior walls are flanked between the top section and the bottom section of the second spacing cup; and wherein the second spacing cup comprises an interior area that is adapted to house the second drive shaft coupling unit; a second sealing plate between the bottom section of the second separation cup and the top end of the second mixing reactor to prevent the mixed substances inside the second mixing reactor from entering the second spacing cup; wherein the top end of the second pump housing is connected to the bottom end of the second mixing reactor and the top end of the second mixing reactor is connected to the bottom section of the second spacing cup;

wherein the top end of the second drive shaft coupling unit is coupled to the second actuator, and the bottom end of the second drive shaft coupling unit is coupled to the top end of the second drive shaft; wherein the bottom end of the second drive shaft is coupled to the coupling unit of the second rotor; wherein the second actuator transmits rotational motion to the second drive shaft, which in turn, drives the second rotor; wherein the hollow tube of the first mixing reactor and the hollow tube of the second mixing reactor are connected to each other via a first connecting tube; wherein the first connecting tube comprises at least one inlet and at least one outlet; wherein the at least one inlet on the first connecting tube is adapted to receive at least a second substance to be mixed in the corresponding mixing reactor with the first substance drawn from the corresponding progressive cavity pump; and wherein the at least one outlet on the first connecting tube is adapted to release the mixed substances.

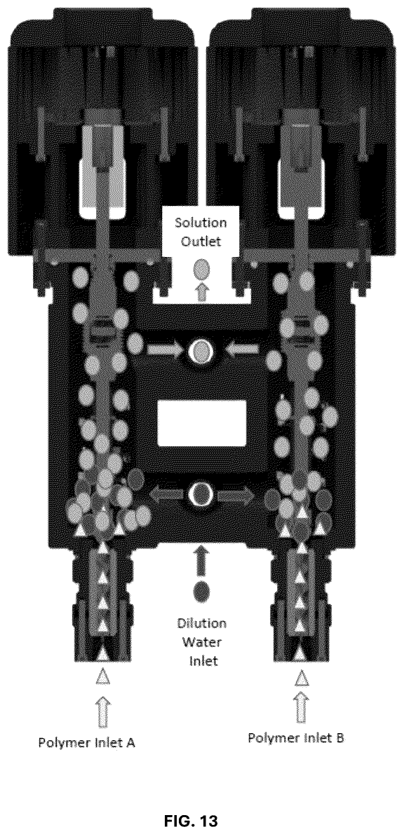

The flow of substances within the dual liquid polymer along the dual liquid polymer dosing and mixing chamber is shown in FIG. 13. Specifically, the first substance enters via each inlet 10c on the corresponding pump housing 10, after passing through the corresponding progressive cavity pump CP, the first substance is led to the corresponding mixing reactor 20. Simultaneously, the second substance is introduced via the one or more inlets IN1-IN2 on the bottom connecting tuba 90a where it is led to the corresponding mixing reactor 20 to be mixed with the first substance via the corresponding one or more impellers IM. The mixed substance is then pushed upwards by the impellers until reaching the one or more outlets OL1-OL2 on the top connecting tube 90b where the mixed substance finally exits the polymer dosing and mixing chamber B.

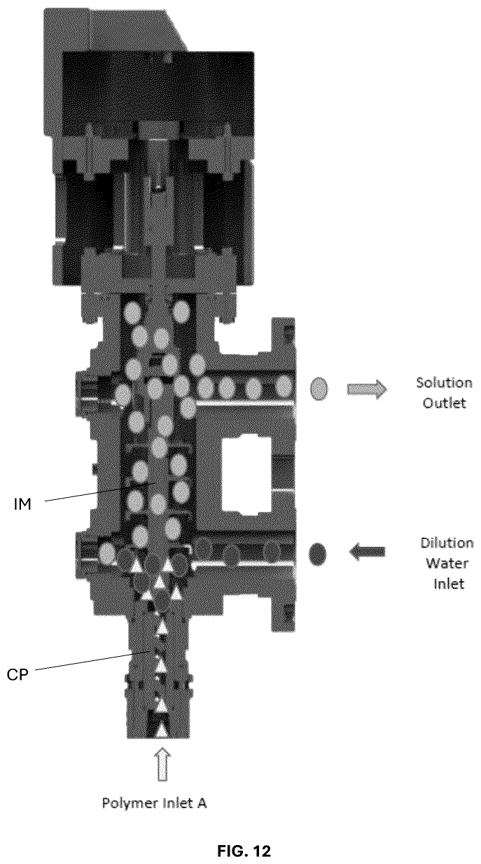

The flow of the substances is similar in the liquid polymer dosing and mixing chamber A. As shown in FIG. 12, the first substance enters via the inlet 10c on the pump housing 10, after passing through the progressive cavity pump CP, the first substance is led to the mixing reactor 20. Simultaneously, the second substance is introduced via the one or more inlets IN1-IN2 on the mixing reactor to be mixed with the first substance via the one or more impellers IM. The mixed substance is then pushed upwards by the one or more impellers until reaching the one or more outlets OL1-OL2 on mixing reactor 20 where the mixed substance finally exits the polymer dosing and mixing chamber A.

While the invention has been described as having a preferred design, it is understood that many changes, modifications, variations and other uses and applications of the subject invention will, however, become apparent to those skilled in the art without materially departing from the novel teachings and advantages of this invention after considering this specification together with the accompanying drawings. Accordingly, all such changes, modifications, variations and other uses and applications which do not depart from the spirit and scope of the invention are deemed to be covered by this invention as defined in the following claims and their legal equivalents. In the claims, means-plus-function clauses, if any, are intended to cover the structures described herein as performing the recited function and not only structural equivalents but also equivalent structures.

All of the patents, patent applications, and publications recited herein, and in the Declaration attached hereto, if any, are hereby incorporated by reference as if set forth in their entirety herein. All, or substantially all, the components disclosed in such patents may be used in the embodiments of the present invention, as well as equivalents thereof. The details in the patents, patent applications, and publications incorporated by reference herein may be considered to be incorporable at applicant's option, into the claims during prosecution as further limitations in the claims to patentable distinguish any amended claims from any applied prior art.

What is claimed is:

1. A liquid polymer dosing and mixing chamber, comprising:
a pump housing, a mixing reactor, a spacing cup, an actuator, a drive shaft, a drive shaft coupling unit, and a progressive cavity pump;
wherein the pump housing comprises a longitudinal body having a top end and an opposing bottom end, and wherein said pump housing is adapted to house the progressive cavity pump;
wherein the bottom end of the pump housing includes an inlet configured to receive a first substance and direct it into the progressive cavity pump;
wherein the progressive cavity pump comprises a rotor and a stator, said rotor being configured to interact with and fit inside the stator;
wherein the top end of the pump housing has an opening to transfer the first substance from the progressive cavity pump into the mixing reactor;
wherein the mixing reactor comprises a hollow tube having a top end and a bottom end opposite each other, and wherein said mixing reactor is configured to house the drive shaft;
wherein the drive shaft comprises a longitudinal body having a top end, a bottom end, and one or more impellers, and wherein the one or more impellers are positioned between the top end and the bottom end of the drive shaft;
wherein the drive shaft coupling unit comprises a top end and an opposing bottom end;
wherein the rotor comprises a coupling unit configured to couple or connect to the bottom end of the drive shaft;
wherein the hollow tube of the mixing reactor includes one or more inlets and one or more outlets attached thereto;
wherein the one or more inlets on the hollow tube of the mixing reactor are adapted to receive at least a second substance to be mixed in the mixing reactor with the first substance drawn from the progressive cavity pump;
wherein the spacing cup comprises a longitudinal structure having a top section, a bottom section, and one or more exterior walls, wherein the exterior walls are flanked between the top section and the bottom section of the spacing cup;
wherein the spacing cup comprises an interior area that is adapted to house the drive shaft coupling unit;
a sealing plate between the bottom section of the separation cup and the top end of the mixing reactor to prevent the mixed substances inside the mixing reactor from entering the spacing cup;
wherein the top end of the pump housing is connected to the bottom end of the mixing reactor and the top end of the mixing reactor is connected to the bottom section of the spacing cup;
wherein the top end of the drive shaft coupling unit is coupled to the actuator, and the bottom end of the drive shaft coupling unit is coupled to the top end of the drive shaft;
wherein the bottom end of the drive shaft is coupled to the coupling unit of the rotor; and
wherein the actuator transmits rotational motion to the drive shaft, which in turn, drives the rotor.

2. The liquid polymer dosing and mixing chamber of claim 1, further comprising a protective cap adapted to protect the actuator.

3. The liquid polymer dosing and mixing chamber of claim 1, wherein exterior walls of the spacing cup include one or more openings or windows configured to provide ventilation and/or a view of the interior area of the spacing cup.

4. The liquid polymer dosing and mixing chamber of claim 1, wherein the sealing plate includes an opening adapted to provide the top end of the drive shaft with access into the interior area of the spacing cup so that the drive shaft can be attached to the shaft coupling unit.

5. The liquid polymer dosing and mixing chamber of claim 1, wherein the drive shaft comprises a mechanical seal to prevent the access of the mixed substances within the mixing reactor into the spacing cup.

6. The liquid polymer dosing and mixing chamber of claim 1, wherein the drive shaft includes a flexible joint that absorbs and dissipates energy through its ability to compress, stretch, or deform elastically in response to vibration of the drive shaft during operation of the actuator and impellers.

7. A dual liquid polymer dosing and mixing chamber, comprising:
a first pump housing, a first mixing reactor, a first spacing cup, a first actuator, a first drive shaft, a first drive shaft coupling unit, and a first progressive cavity pump;
wherein the first pump housing comprises a longitudinal body having a top end and an opposing bottom end, and wherein said first pump housing is adapted to house the first progressive cavity pump;
wherein the bottom end of the first pump housing includes an inlet configured to receive a first substance and direct it into the first progressive cavity pump;
wherein the first progressive cavity pump comprises a first rotor and a first stator, said first rotor being configured to interact with and fit inside the first stator;
wherein the top end of the first pump housing has an opening to transfer the first substance from the first progressive cavity pump into the first mixing reactor;
wherein the first mixing reactor comprises a hollow tube having a top end and a bottom end opposite each other, wherein said first mixing reactor is configured to house the first drive shaft;
wherein the first drive shaft comprises a longitudinal body having a top end, a bottom end, and one or more impellers, and wherein the one or more impellers are positioned between the top end and the bottom end of the first drive shaft;
wherein the first drive shaft coupling unit comprises a top end and an opposing bottom end;
wherein the first rotor comprises a coupling unit adapted to couple or connect to the bottom end of the first drive shaft;
wherein the first spacing cup comprises a longitudinal structure having a top section, a bottom section, and one or more exterior walls, wherein the exterior walls are flanked between the top section and the bottom section of the first spacing cup;
wherein the first spacing cup comprises an interior area that is adapted to house the first drive shaft coupling unit;
a first sealing plate between the bottom section of the first separation cup and the top end of the first mixing reactor to prevent the mixed substances inside the first mixing reactor from entering the first spacing cup;
wherein the top end of the first pump housing is connected to the bottom end of the first mixing reactor and the top end of the first mixing reactor is connected to the bottom section of the first spacing cup;
wherein the top end of the first drive shaft coupling unit is coupled to the first actuator, and the bottom end of the first drive shaft coupling unit is coupled to the top end of the first drive shaft;
wherein the bottom end of the first drive shaft is coupled to the coupling unit of the first rotor;
wherein the first actuator transmits rotational motion to the first drive shaft, which in turn, drives the first rotor;
a second pump housing, a second mixing reactor, a second spacing cup, a second actuator, a second drive shaft, a second drive shaft coupling unit, and a second progressive cavity pump;
wherein the second pump housing comprises a longitudinal body having a top end and an opposing bottom end, and wherein said second pump housing is adapted to house the second progressive cavity pump;
wherein the bottom end of the second pump housing includes an inlet configured to receive a first substance and direct it into the second progressive cavity pump;
wherein the second progressive cavity pump comprises a second rotor and a second stator, said second rotor being configured to interact with and fit inside the second stator;
wherein the top end of the second pump housing has an opening to transfer the first substance from the second progressive cavity pump into the second mixing reactor;
wherein the second mixing reactor comprises a hollow tube having a top end and a bottom end opposite each other, wherein said second mixing reactor is configured to house the second drive shaft;
wherein the second drive shaft comprises a longitudinal body having a top end, a bottom end, and one or more impellers, wherein the bottom end and the top end of the drive shaft are opposite each other and wherein the one or more impellers are positioned between the top end and bottom end of the second drive shaft;
wherein the second drive shaft coupling unit comprises a top end and an opposing bottom end;
wherein the second rotor comprises a coupling unit adapted to couple or connect to the bottom end of the second drive shaft;
wherein the second spacing cup comprises a longitudinal structure having a top section, a bottom section, and one or more exterior walls, and wherein the exterior walls are flanked between the top section and the bottom section of the second spacing cup;
wherein the second spacing cup comprises an interior area that is adapted to house the second drive shaft coupling unit;
a second sealing plate between the bottom section of the second separation cup and the top end of the second mixing reactor to prevent the mixed substances inside the second mixing reactor from entering the second spacing cup;
wherein the top end of the second pump housing is connected to the bottom end of the second mixing reactor and the top end of the second mixing reactor is connected to the bottom section of the second spacing cup;
wherein the top end of the second drive shaft coupling unit is coupled to the second actuator, and the bottom end of the second drive shaft coupling unit is coupled to the top end of the second drive shaft;
wherein the bottom end of the second drive shaft is coupled to the coupling unit of the second rotor;
wherein the second actuator transmits rotational motion to the second drive shaft, which in turn, drives the second rotor;
wherein the hollow tube of the first mixing reactor and the hollow tube of the second mixing reactor are connected to each other via a first connecting tube;
wherein the first connecting tube comprises at least one inlet and at least one outlet;
wherein the at least one inlet on the first connecting tube is adapted to receive at least a second substance to be mixed in the corresponding mixing reactor with the first substance drawn from the corresponding progressive cavity pump; and
wherein the at least one outlet on the first connecting tube is adapted to release the mixed substances.

8. The dual liquid polymer dosing and mixing chamber of claim 7, further comprising a protective cap adapted to protect the first actuator or the second actuator.

9. The dual liquid polymer dosing and mixing chamber of claim 1, wherein exterior walls of the first spacing cup include one or more openings or windows configured to provide ventilation and/or a view of the interior area of the first spacing cup.

10. The dual liquid polymer dosing and mixing chamber of claim 1, wherein exterior walls of the second spacing cup include one or more openings or windows configured to provide ventilation and/or a view of the interior area of the second spacing cup.

11. The dual liquid polymer dosing and mixing chamber of claim 7, wherein the first sealing plate includes an opening adapted to provide the top end of the first drive shaft with access into the interior area of the first spacing cup so that the first drive shaft can be attached to the first shaft coupling unit.

12. The dual liquid polymer dosing and mixing chamber of claim 7, wherein the second sealing plate includes an opening adapted to provide the top end of the second drive shaft with access into the interior area of the second spacing cup so that the second drive shaft can be attached to the second shaft coupling unit.

13. The dual liquid polymer dosing and mixing chamber of claim 7, wherein the first drive shaft comprises a mechanical seal to prevent the access of the mixed substances within the first mixing reactor into the first spacing cup.

14. The dual liquid polymer dosing and mixing chamber of claim 7, wherein the second drive shaft comprises a mechanical seal to prevent the access of the mixed substances within the second mixing reactor into the second spacing cup.

15. The dual liquid polymer dosing and mixing chamber of claim 7, wherein the first drive shaft includes a flexible joint that absorbs and dissipates energy through its ability to compress, stretch, or deform elastically in response to vibration of the first drive shaft during operation of the first actuator and corresponding impellers.

16. The dual liquid polymer dosing and mixing chamber of claim 7, wherein the second drive shaft includes a flexible joint that absorbs and dissipates energy through its ability to compress, stretch, or deform elastically in response to vibration of the second drive shaft during operation of the second actuator and corresponding impellers.

17. The dual liquid polymer dosing and mixing chamber of claim 7, wherein the hollow tube of the first mixing reactor and the hollow tube of the second mixing reactor are connected to each other via a second connecting tube.

18. The dual liquid polymer dosing and mixing chamber of claim 17, wherein the second connecting tube comprises at least one inlet and at least one outlet.
